(19) United States
(12) Patent Application Publication
(10) Pub. No.: US 2009/0255485 A1
(43) Pub. Date: Oct. 15, 2009

(54) LEASH ASSEMBLY FOR A PET COLLAR AND A COMBINED COLLAR AND LEASH

(76) Inventors: Robert G. Dickie, Newmarket (CA); Pasi J. Maatta, Ajax (CA)

Correspondence Address: SAND & SEBOLT, AEGIS TOWER, SUITE 1100, 4940 MUNSON STREET, NW, CANTON, OH, 44718-3615, US

(21) Appl. No.: 12/100,896

(22) Filed: Apr. 10, 2008

(51) Int. Cl. A01K 27/00

(52) U.S. Cl. 119/794; 119/792

(57) ABSTRACT

A leash assembly for a pet collar and a combined collar and leash. A base assembly is permanently or temporarily engaged with the collar. The leash assembly, which has an internal retractor mechanism, is detachably seated on the base assembly and is connected thereto by a short leash. When the leash and base assemblies are engaged, the leash is substantially retracted into the leash assembly. The leash assembly may be grasped and pulled out of engagement with the base assembly thus causing a length of the leash to be unwound from the retractor mechanism. The retractor mechanism includes a lock that is engaged unless a release button on the leash assembly is depressed.

### BACKGROUND OF THE INVENTION

1. Technical Field

This invention generally relates to pet products. More particularly, the invention relates to devices for controlling animals. Specifically, the invention relates to a leash assembly connected via a short leash to a base assembly engaged with a pet collar, the lease assembly includes a retractor mechanism that retracts the leash therein when the leash and base assemblies are in contact and dispenses the leash therefrom when the leash assembly is separated from the base assembly.

2. Background Information

There are a wide variety of different sizes, styles and price ranges of pet collars for a pet owner to choose from. Similarly, there are a wide variety of types and styles of leashes that are available and are designed to clip to a metal ring on the collar. Leashes are designed for a range of different conditions. Leashes may be between five and six feet long and are suitable for walking a dog in reasonably high traffic areas where the owner wishes to keep the dog alongside him. A different type of leash may be utilized when the owner wishes to take the animal outside for a long walk in an open area or or where the animal is taken outside for performing bodily functions. In this instance, a long, corded retractable leash may be clipped to the collar. The leash permits the owner to let their pet wander some distance from them but can be quickly and easily retracted when the animal needs to be brought into closer proximity to the owner.

There are some situations, however, where the owner does not have time to clip a leash to the collar. One such situation is where someone comes to the front door and the owner needs to answer the door and control their animal at the same time. In such instances, it is typical for the owner to directly grab hold of the collar and attempt to use the collar itself to control the dog. Another situation where the owner may have problems is where their pet has to be moved into and out of a car. In this type of situation, the owner may either tend to try and hang onto the collar itself to control the animal, or attach a leash and leave it attached once the animal is in the vehicle. The former course of action may be problematic as the animal may break free during the transition from ground to car or vice versa. The second course of action may be problematic as a leash hanging from the collar may snag on components on the interior of the vehicle while the owner is driving.

A variety of solutions have been proposed in the art to address such situations. One of the proposed solutions is a combination pet collar and leash. An example of such a device is disclosed in U.S. Pat. No. 4,328,767, issued to Peterson. This patent discloses a pet collar which includes a leash includes a leash connected to a retractor mechanism mounted on the underside of a pet collar. A handle is attached to the end of the leash and a guide ring is spaced on the topside of the collar, some distance away from the retractor. The guide ring acts as a stop for the handle. A stiffening member is also provided on the collar intermediate the retractor mechanism and the guide ring. It is likely that if the collar is put on the animal incorrectly that the weight of the retractor mechanism will rotate the collar to the correct position. The disclosed configuration of the collar is cumbersome and there are too many components projecting outwardly from the exterior of the collar which could easily snag the pet on objects.

U.S. Pat. No. 5,816,198, also issued to Peterson, discloses a similar system to that of the '767 patent, except that all the components are encased on this device, thus reducing the tendency of the collar to snag objects. In this version, the retractor is designed to rest on the top of the pet's neck and a counterbalance is provided on the opposite side of the collar to prevent the retractor from rotating the collar under the influence of gravity. A handle is connected to the free end of the leash and a stop for the handle is situated adjacent the retractor mechanism. The design is, again, too cumbersome and complex.

U.S. Pat. No. 6,481,382, issued to Cohn, discloses a pet collar that includes an interior channel in which an elastic cord is secured. One end of the cord extends outwardly through an aperture in the exterior wall of the collar. A collar. A small handle is provided at the free end of the cord. When the user wishes to restrain the pet, they grasp the handle and pull a portion of the cord out of the collar. When the handle is released, the cord reverts to its original length and is retracted into the collar. The material of the cord is, itself, therefore the retraction mechanism. The design of this collar might be suitable for smaller, lightweight pets but would be unsuitable for larger, stronger breeds of dogs, for example. The larger animals would easily be able to extend the cord to its maximum length and would therefore be more difficult to control. Furthermore the disclosed handle would be completely inadequate for the task of holding on to a larger dog because of the handle's small size. Additionally, the design of the handle makes it likely that the handle would catch onto objects as the pet moves past them. Replacement of the disclosed handle with one of a more substantive nature would result in a larger object-catching hazard dangling from the animal's neck.

U.S. Pat. No. 6,581,547, issued to Austin, discloses a pet collar with a retractable leash. The collar includes a specially designed pouch on its exterior surface and the leash is retained within this pouch. A handle on the leash is detachably retained on the outside surface of the collar by way of snaps, hook and loop fasteners and the like. A recoil mechanism is secured to the leash at the opposite end of the pouch from the handle.

U.S. Pat. No. 7,017,527, issued to Price, shows a pet collar having a pair of spaced-apart recoilers permanently mounted thereon. A cord extends outwardly from each recoiler and the free end of each cord has a portion of a handle member attached thereto. Each handle portion includes a detachable fastener and the two handle portions are connected by these fasteners to form a handle for the leash. When the handle is grasped and pulled outwardly, cord is dispensed from each recoiler. When the handle is released, the cords wind back into the recoilers. The recoilers are not provided with any mechanisms for controlling the rate at which cord is dispensed therefrom nor is there any mechanism for preventing or the dispensing of the cord. The device could be problematic in that an animal wearing the same could become entangled if a protruding object separates the handle from the collar when the animal is moving past the object.

U.S. Pat. No. 7,150,247, issued to Eulette et al, discloses a retracting leash that is designed to attach to a pet collar. A lightweight housing is permanently attached to the collar and a leash is retained within the housing and extends outwardly therefrom. The housing includes a mechanism for retracting the leash. An ergonomically designed handle is attached to the free end of the leash remote from the housing. The handle is designed to fit against the housing when the leash is fully retracted.

U.S. Pat. No. 7,174,857, issued to Lord, discloses a collar having a retractor housing mounted thereon. The housing may be permanently attached to the collar or may be detachably connected thereto. However, the only method of temporary attachment disclosed is the provision of a specially formed male or female connector on the housing which is designed to engage a mating connector on the collar. A leash extends outwardly from the housing and is provided with a handle at the end thereof. A fastener, such as a hook and loop fastener is used to secure the handle onto the exterior surface of the collar. The housing includes a spring-biased, rotatable spool around which the full-length leash is wound and unwound. A stop, provided within the housing, engages detents on the spool and thereby selectively prevents its rotation. The stop is disengaged by way of a release button and when disengaged, the leash may be extended from the housing or retracted into the housing. When the owner pulls on the handle, the leash is withdrawn from the housing. When the handle is released, the retractor within the housing winds the leash back onto the spool. The handle is securable to the exterior of the collar, but may be easily separated therefrom by projecting objects that the animal may pass.

There is therefore a need in the art for an improved pet collar that includes a retractable leash which is quickly and easily accessed and retracted and that presents a reduced snagging hazard for the animal.

### SUMMARY OF THE INVENTION

The device of the present invention comprises a leash assembly for a pet collar and a combined collar and leash. A base assembly is permanently or temporarily engaged with the collar. The leash assembly, which has an internal retractor mechanism, is detachably seated on the base assembly and is connected thereto by a short leash. When the leash and base assemblies are engaged, the leash is substantially retracted into the leash assembly. The leash assembly may be grasped and pulled out of engagement with the base assembly thus causing a length of the leash to be unwound from the retractor mechanism located therein. The leash assembly with a retractor mechanism therein constitutes a handle for the leash. When the handle is released, the retractor mechanism winds the leash back onto a spool retained within the leash assembly and draws the leash assembly back into engagement with the base assembly. The retractor mechanism includes a lock that is engaged unless a release button on the leash assembly is depressed. Thus, when the leash assembly is seated on the base assembly, the lock is engaged and the leash assembly cannot therefore be separated accidentally from the base assembly by the normal activities of the animal wearing the collar.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of the combined pet collar and leash in accordance with the present invention and in which the leash assembly is shown in a partially dispensed position;

FIG. 2 is a perspective view of the combined pet collar and leash with the leash assembly shown in the fully retracted position;

FIG. 3 is an exploded perspective view of the leash of the present invention shown with the leash cord removed for clarity;

FIG. 4 is a perspective view of the leash assembly fitted to the collar and having the top cover of the leash assembly removed;

FIG. 5 is a perspective view of the base locator of the leash assembly being engaged with the collar;

FIG. 6 is a top view of the leash assembly engaged with the collar;

FIG. 7 is a cross-sectional side view of the leash assembly engaged with the collar as taken through line 7-7 of FIG. 6;

FIG. 8 is a bottom view of the leash assembly shown with the brake in a locked position in which the gears are prevented from rotating;

FIG. 9 is a bottom view of the leash assembly with the brake in a released position in which the gears are free to rotate;

FIG. 10 is a bottom view of an alternative embodiment of a leash assembly that includes a single hub from which the two leash cords extend,

FIG. 11 is a side view of the hub of FIG. 10 showing the two leash cords extending outwardly in opposite directions from the hub;

FIG. 12 is a perspective view of an alternative method of securing the locator base to a pet collar;

FIG. 13 is a side view of the collar and locator base as shown in FIG. 12; and

FIG. 14 is a side view of the leash assembly engaged with the locator base.

### DETAILED DESCRIPTION OF THE INVENTION

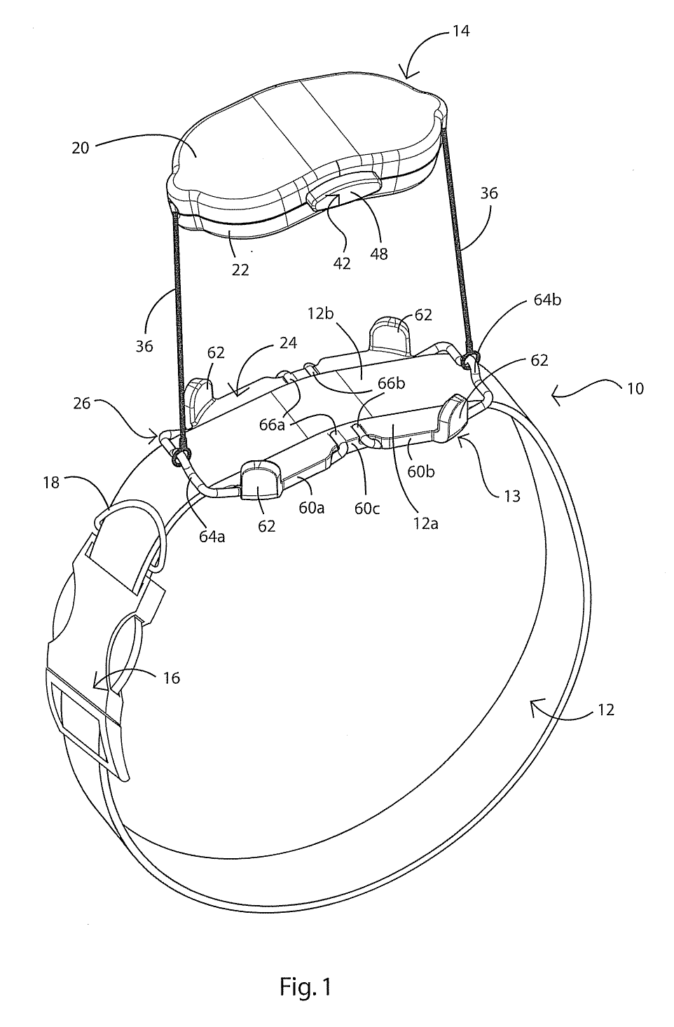

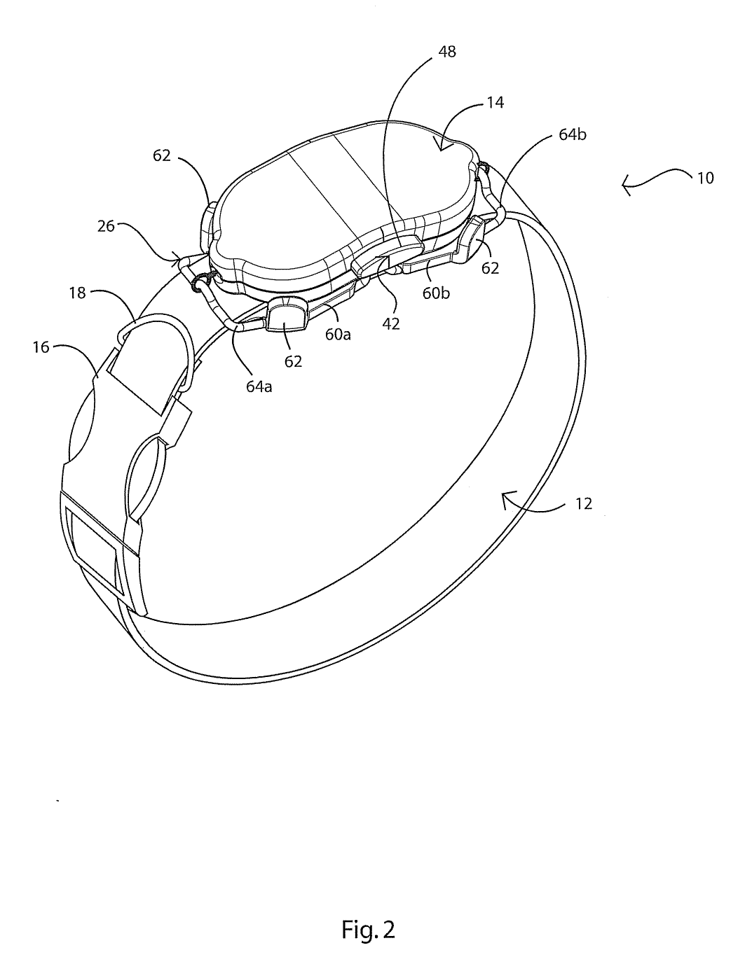

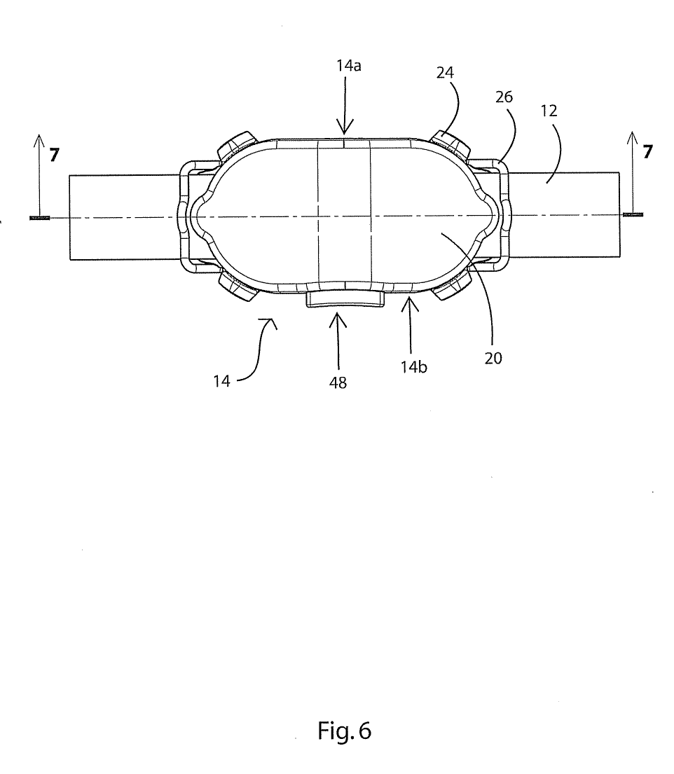

Referring to FIGS. 1-9 there is shown a combined pet collar and leash in accordance with the present invention and generally indicated at 10. The combined pet collar and leash 10 comprises a strap-type collar 12 that is engaged by a base assembly 13 and a leash assembly 14. Base assembly 13 is detachably engaged with collar 12 and leash assembly 14 is seated within base assembly 13 or is otherwise engaged therewith. A short leash 36 extends between base assembly 13 and leash assembly 14. Leash assembly 14 includes a retractor mechanism as will be hereinafter described. Leash assembly 14 acts as a handle for the leash 36. When leash assembly 14 is grasped and moved away from base assembly 13, leash 36 is dispensed from the retractor mechanism. When leash assembly 14 is released, leash 36 is retracted back into the interior of leash assembly 14. The retraction of leash 36 leash 36 also draws leash assembly 14 back into seating engagement with base assembly 13. Collar 12 includes a connector 16, 17 at either end and a metal ring 18 to which other leashes (not shown) may selectively be attached. FIG. 1 shows leash assembly 14 in an extended position and FIG. 2 shows leash assembly 14 in a retracted position.

In accordance with the present invention, leash assembly 14 includes a top cover 20 and a body 22 that are secured together by sonic welding. Base assembly 13 comprises a base 24 and a leash clip 26 for temporarily engaging collar 12 and providing a seat for retaining leash assembly 14 therein when in the retracted position (FIG. 2). Cover 20, body 22 and base 24 preferably are all injection molded from a high strength polycarbonate resin, such as that marketed under the trademark LEXAN by the General Electric Company of Pittsfield, Mass. Cover 20 and body 22 are ergonomically designed to be easily grasped and seated within a person's hand as they will act as a handle for the leash.

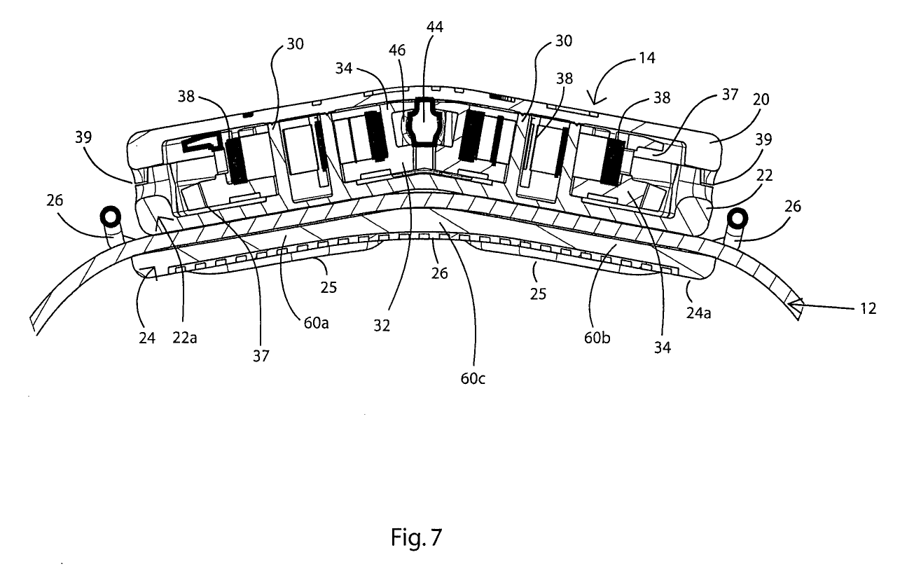

Locator base 24 of base assembly 13 is configured to conform to an animal's neck region so that it will be easily and comfortably worn by the animal. Locator base 24 comprises a substantially planar member that has a first lobe 60a and a second lobe 60b connected together by a saddle 60c. Lobes 60a, 60b are of a slightly greater width than saddle 60c. Preferably, lobes 60a, 60b will be of a width suitable to extend outwardly beyond the side edges 12a, 12b of collar 12. Both of the outermost ends of saddle 60c are provided with one or more channels 63 that are positioned to receive a portion of leash clip 26 therein. As shown in FIG. 7, the planar member of base is arcuate in shape. More specifically, base 24 is convex in cross-sectional shape so as to be able to be complementary shaped to the curved region of shape of the top of a dog's neck region. The bottom surface 24a of locator base 24 includes one or more elastomeric pads 25 that directly abut the fur of the animal. Pads 25 aid in reducing the tendency of collar 12 to rotate on the dog's neck thereby aiding in retaining leash assembly 14 in a position on the top part of the animal's neck where it may be easily grasped.

A plurality of flanges 62 extend vertically upwardly away from the substantially horizontal planar member of base 24. Flanges 62 are positioned to capture and retain leash assembly 14 therebetween when leash assembly 14 is in the retracted position (FIG. 2). Leash assembly 14 is thus seated on the planar member 60 and is retained between flanges 62.

Locator base 24 is secured to collar 12 by the spring loaded leash clip 26. Leash clip 26 may comprise one or two members that are manufactured from a very high strength steel and are generally shaped in like manner to the lobes 60 of locator base 24. In the version shown in the attached drawings, leash clip 26 comprises two separate members, those being first member 64a which is configured to engage a bottom surface of first lobe 60a, and a second member 64b configured to engage a bottom surface of second lobe 60b. First member 64a includes fingers 66a at either end thereof that are received in received in channels 63 of saddle 60c. Second member 64b includes fingers 66b at either end thereof that are received in channels 63 of saddle 60c. Each of first and second members 64a, 64b is bent into a shape that will spring bias locator base 24 into engagement with a bottom surface of collar 12.

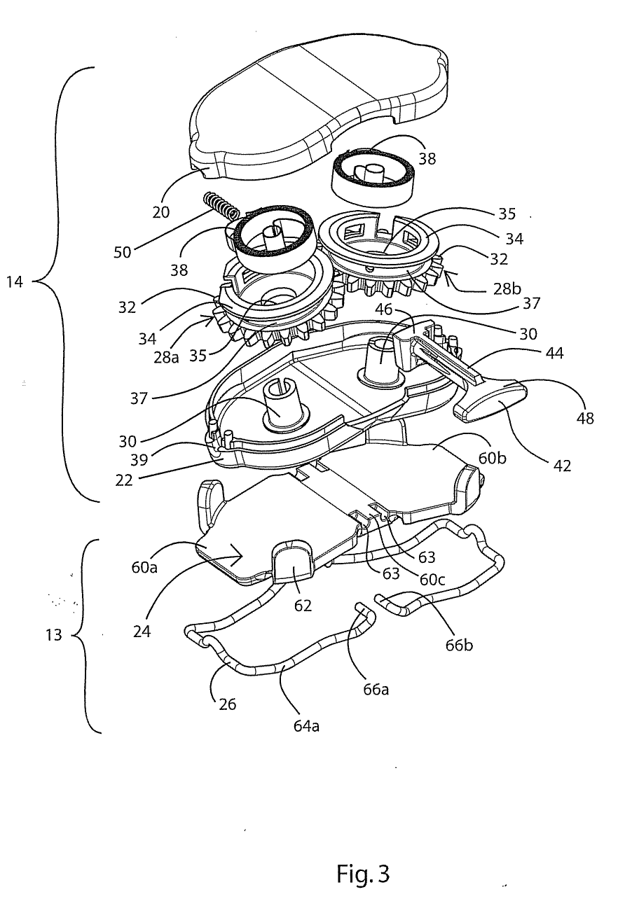

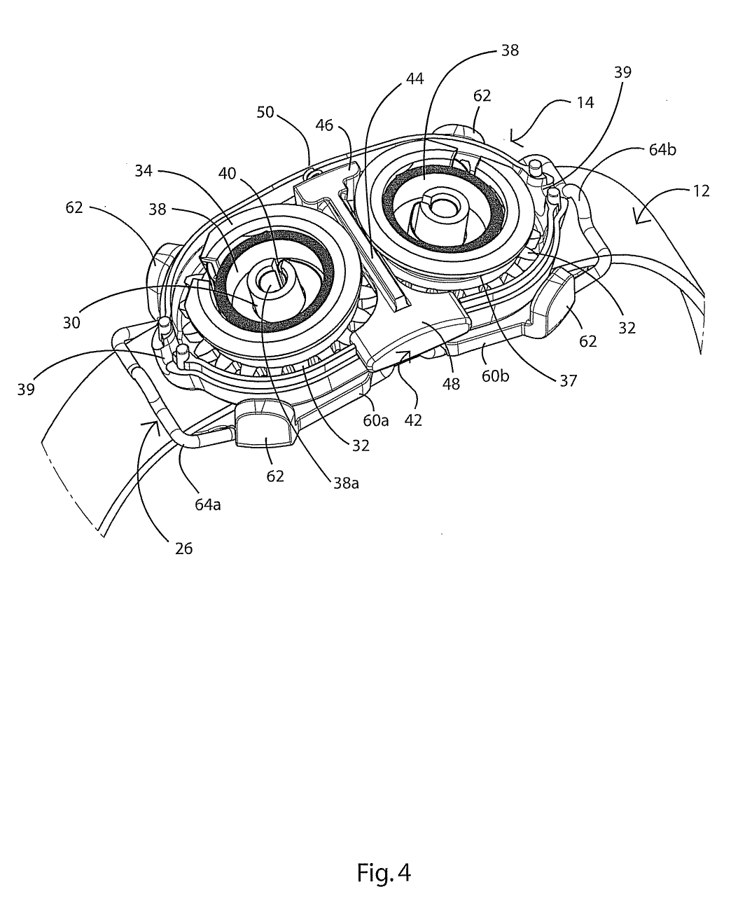

Referring to FIGS. 3 and 4, the retractor mechanism housed within the cavity formed by top cover 20 and body 22 of leash assembly 14 includes a pair of gear hubs 28a, 28b. Hubs 28a, 28b are mounted on posts 30 extending outwardly from an interior surface of body 22. Each gear hub 28 has a plurality of large, thick teeth 32 that extend radially outwardly therefrom. The teeth on gear hub 28a are designed to mesh with those on gear hub 28b. Each hub 28a, 28b further includes a spool 34 having a central aperture 35 therein. Each post 30 is received through an aperture 35 in one of hubs 28a, 28b and the hubs are rotatable about these stationary posts 30. Hubs 28a, 28b preferably are geared to rotate in opposite directions from each other. So, for example, when hub 28a rotates in a clockwise direction, hub 28b will rotate in a counterclockwise direction and vice versa.

The leash extending between base assembly 13 and leash assembly 14 preferably comprises a pair of thin, but strong, nylon leash cords (shown in FIG. 1 but not in FIG. 3). Each leash cord 36 is wrapped around an exterior channel 37 of each spool 34. Each leash cord 36 passes through a tapered aperture 39 in the peripheral wall of body 22 and is secured to a portion of leash clip 26 by a suitable means. The total length of each leash cord 36 is relatively short, as the combined leash and collar device is meant to be used to temporarily restrain and control a dog, it is not designed to be used when taking the dog on a long walk. A suitable length for leash cords 36 is between fifteen and thirty inches. A length of around twenty inches has been found to be suitable for controlling most breeds of dog.

The retractor mechanism further includes a coil spring 38 that is retained within at least one, and preferably both, spools 34. Coil springs 38 are manufactured from spring steel and a first end of each coil spring 38 is secured to an interior wall of one of spools 34. A second end of each coil spring 38 is engaged in a slot 40 in the associated post 30. When leash assembly 14 is pulled outwardly away from collar 12, leash cords 36 are unwound from spools 34. This causes hubs 28a, 28b to rotate in opposite first directions. This movement, in turn, causes coils springs 38 to become tightly wound up around posts 30, i.e., the tension in the springs 38 is increased.

When leash assembly 14 is released, the tension on leash cords 36 is released and, consequently, coil springs 38 revert to their original condition. This, in turn causes hubs 28a, 28b to rotate in respective opposite second directions, thereby winding leash cords 36 back onto spools 34. The interlocking teeth 32 extending radially outwardly from hubs 28a, 28b ensure that the hubs rotate in unison and that the leash cords 36 are released from both hubs 28a, 28b at substantially the same rate, and are wound up on both hubs 28a, 28b at substantially the same rate. This ensures that the leash assembly 14, which acts as a handle in the owner's hand, is always straight, no matter the extent to which the leash cords 36 have been fed out of leash assembly 14. The forces acting on leash assembly 14 are therefore evenly distributed across assembly 14. This reduces the tendency of leash cords 36 to snag while being dispensed or retracted, and further reduces the chances of lease assembly 14 failing.

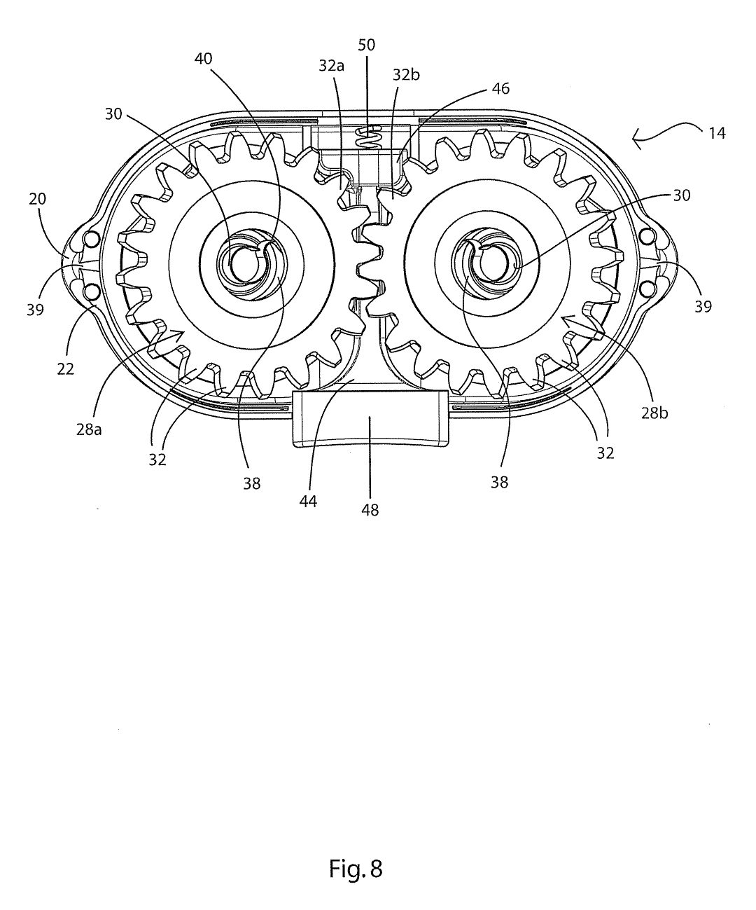

Leash assembly 14 is also provided with a locking mechanism 42 that is movable between an engaged position and a released position. When locking mechanism 42 is in the engaged position, leash assembly 14 is locked in place relative to locator base 24 and leash cords 36 can neither be dispensed from leash assembly 14 nor be retracted into the same. When locking mechanism 42 is disengaged, leash assembly 14 may be pulled outwardly away from locator base 24 or may be drawn back toward the same. Locking mechanism 42 includes a lock shaft 44 with a die-cast, zinc gear stop 46 at one end and a release button 48 at the other end. A compression spring 50 is disposed between an interior surface of the peripheral wall of body 22 and gear stop 46. Lock shaft 44 is shaped and sized to be received between hubs 28a, 28b and to travel horizontally back and forth within a groove formed by channels 37 in hubs 28a, 28b. A portion of release button 48 extends outwardly from the exterior surface of the peripheral wall of body 22. When locking mechanism 22. When locking mechanism 42 is in a locked position (FIG. 8) compression spring 50 is fully expanded and urges release button 48 outwardly away from the exterior surface of cover 20 and body 22. Consequently, a smaller portion of release button 48 is disposed within the interior of leash assembly 14 and a larger portion of release button 48 is disposed exteriorly of the leash assembly 14. FIG. 8 also shows that when the locking mechanism is in this engaged or locked position, gear stop 46 engages one or more of the plurality of teeth 32 of one or more of hubs 28a, 28b. For example, gear stop 46 may engage teeth 32a and 32b. This engagement substantially prevents any further rotational movement of hubs 28a, 28b, and leash cords 36 therefore cannot be wound or unwound on spools 34.

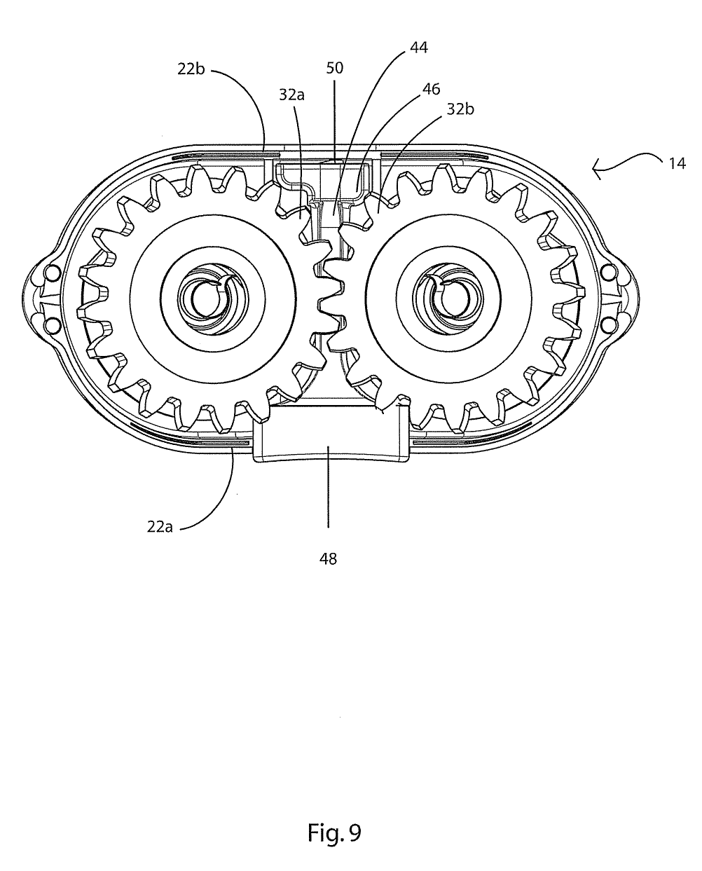

In order to disengage or unlock locking mechanism 42 (FIG. 9), release button 48 is pushed inwardly toward an exterior surface on the first side 22a of the peripheral wall of body 22. Lock shaft 44 is thereby caused to travel inwardly toward the opposite side 22b of the peripheral wall of body 22, thereby compressing compression spring 50 between gear stop 46 and the interior wall of side 22b. In this disengaged position, a greater portion of the release button 48 is retained within the interior of leash assembly 14 and a lesser portion thereof extends outwardly from leash assembly. As shown in FIG. 9, when in this disengaged position, gear stop 46 no longer contacts teeth 32a, 32b of gear hubs 28a, 28b. Thus, the hubs 28a, 28b are free to rotate when leash assembly 14 is pulled outwardly away from collar 12 or is moved moved toward collar 12.

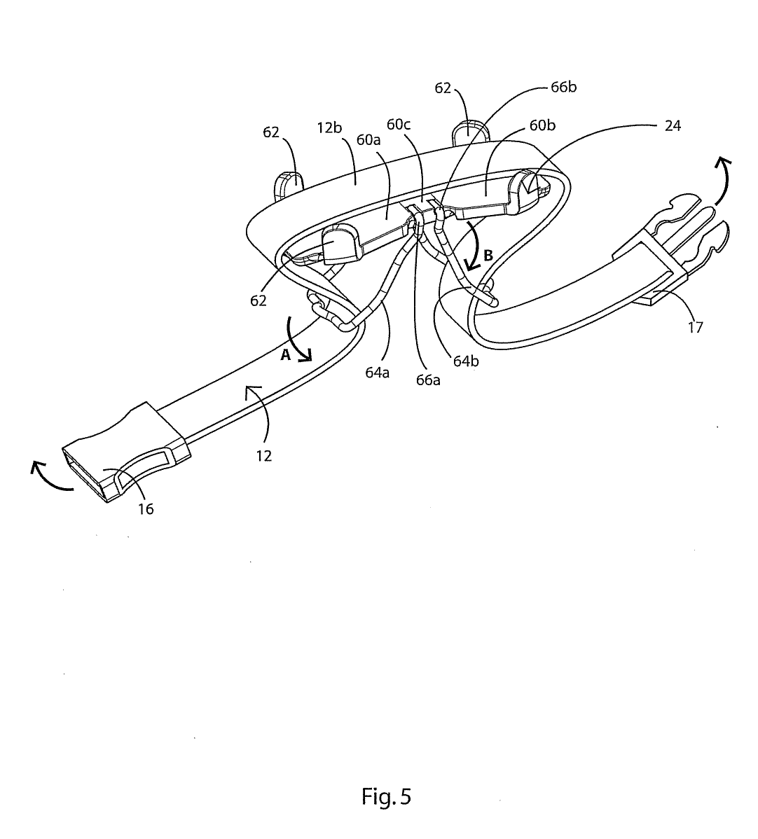

The embodiment of the present invention shown in FIGS. 1-9 is designed to be removably fitted to collar 12. FIG. 5 shows base assembly 13, with locator base 24 and leash clip 26 being engaged with a typical, strap-type dog collar 12. The leash assembly 14 is not shown in this drawing for the sake of clarity. It will be understood that leash assembly 14 is connected to the locator base 24 by way of the two leash cords 36 and is seated between flanges 62 thereof. The locking mechanism retained within leash assembly 14 would be disengaged during installation of the device on a collar 12 by depressing release button 44. In order to fit base assembly 13 onto collar 12, the collar 12 has to be threaded between a portion of leash clip 26 and locator base 24. First region 64a of the leash clip 26 is rotated downwardly away from locator base 24 in the direction of arrow A. Second region 64b of leash clip 26 is rotated downwardly away from locator base in the direction of arrow B. A gap is therefore opened up between the ends of locator base 24 and the leash clip 26. A portion 12b of collar 12 is rested on the outer surfaces of lobes 60a, 60b of locator base 24. A first end of buckle 16 is threaded through the gap between lobe 60a and first region 64a of leash clip 26. A second end of buckle 17 is threaded through the gap between lobe 60b and second region 64b. The buckled ends of collar 12 are then pulled outwardly and upwardly as indicated by arrows C, to take up the slack in collar 12 and to rotate first and second regions 64a, 64b of leash clip 26 into clamping engagement with locating base clamping engagement with locating base 24. It should be noted that a length of collar 12 becomes clamped between locator base 24 and leash clip 26, with clip 26 urging base 24 into engagement with the bottom surface of collar 12. The collar 12 is then placed around the dog's neck and buckle ends 16, 17 are interlocking engaged with each other.

When the owner has a need to temporarily restrain their pet, they grip the sides 14a, 14b of leash assembly 14 between their fingers and push release button 48 inwardly toward side 14b. As previously described, this inward movement of release button 48 slides the locking mechanism 42 within the groove between hubs 28a, 28b and causes gear stop 46 to move toward the interior surface of the 22b (FIG. 9) of body 22. Gear stop 46 compresses spring 50 between stop 46 and surface 22 and causes teeth 32 to disengage from gear stop 46. Hubs 28a, 28b are therefore free to rotate within leash assembly 14 and the owner is therefore able to pull the leash assembly 14 outwardly out of its seat between flanges 62 of locating base 24. The movement of leash assembly 14 causes leash cords 36 to begin to be dispensed from spools 34, which in turn causes hubs 28a, 28b to rotate. Leash assembly 14 can be pulled outwardly away from base assembly 13 until leash cords 36 are fully extended.

As leash assembly 14 separates from locator base 24, the pet owner is able to slide their fingers under the bottom surface 22a of body 22 and fully grasp leash assembly 14 as a handle. This tends to cause the owner to release pressure on the release button 48. Compression spring 50 rebounds to its original length and position, thereby sliding lock shaft 44 away from interior surface 22b of body 22. The movement of lock shaft 44 causes gear stop 46 to engage one or more teeth 32 on one or both hubs 28a, 28b thus preventing any further rotation of the same. The movement of lock shaft 44 also causes release button 48 to move back into the locked position shown in FIG. 8. It should be noted that gear stop 46 is configured in such a manner that as lock shaft 44 slides from the second position back to the first position, teeth from hub 28a and teeth from hub 28b strike gear stop 46 at substantially exactly the same time. Teeth 32 therefore counteract the forces on gear stop 46 and double the holding power of the hubs 28a, 28b as each hub is caused to bear half the force exerted by pulling on leash cords 36.

When the owner no longer needs to restrain their dog, they push release button 48 inwardly once again to move it back into an unlocked position. At this point, gear stop 46 disengages from teeth 32 on hubs 28a, 28b and coil spring 38 reverts to its original position and condition, winding leash cords 36 back onto spools 34 as it does so. The leash assembly 14 is thereby drawn back into seated engagement with the locating base 24 and is received between flanges 62.

When release button 48 is no longer depressed inwardly, the locking mechanism slides back into the locked position and gear stops 46 prevent any further rotation of hubs 28a, 28b in response to the expansion of coil spring spring 38. Leash assembly 14 is thereby retained in a locked condition on locating base 24 and cannot be easily accidentally disengaged by the normal activities of the animal.

It will be understood that a locking mechanism for substantially preventing relative movement between the leash assembly 14 and base assembly 16 may be provided on the base assembly 16 instead of on the leash assembly 14 as has been disclosed above.

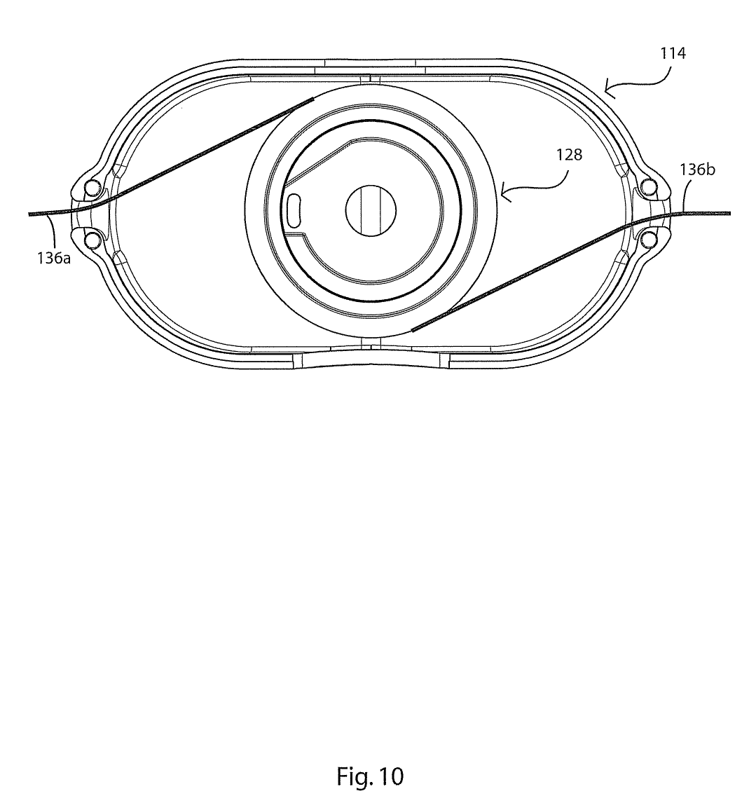

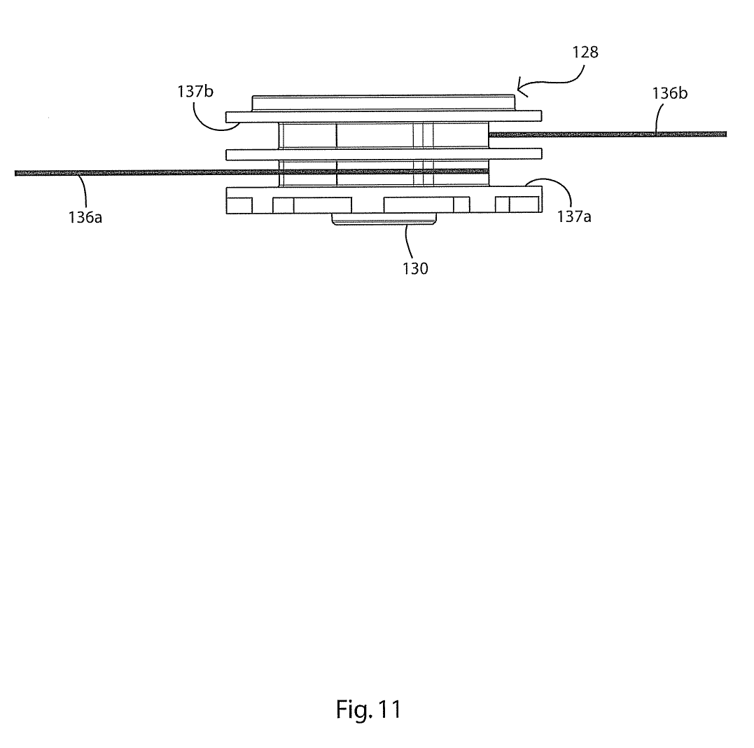

FIGS. 10 and 11 show a third or alternative embodiment of a leash assembly 114 that may be engaged with a locator base (not shown). Leash assembly 114 includes a single hub 128 onto which two leash cords 136a, 136b are secured. Leash cords 136a, 136b are designed to be wound and unwound on the hub 128 in opposite directions from each other. As shown in FIG. 11, hub 128 is thicker than either of hubs 28a, 28b. Hub 128 is generally cylindrical and includes two vertically spaced apart channels 137a, 137b. Leash cord 136a is wound onto hub 128 in channel 137a and leash cord 136b is wound onto hub 128 in channel 137b. Cords 136a, 136b are designed to extend outwardly from hub 128 in opposite directions to each other. Thus, when a locking mechanism (not shown) is disengaged and leash assembly 114 is pulled out of engagement with a base assembly (not shown), hub 138 is rotated around a central axis in a first direction. If the leash assembly 114 is moved back toward the base assembly in response to recoil of a spring, for example, then hub 128 will rotate around a central axis in a second direction. second direction. The rotation of hub 128 causes the two cords 136a, 136b to be either simultaneously wound off from hub 128 at the same rate or simultaneously wound onto hub 128 at the same rate. This embodiment of leash assembly 114 functions well but tends to be slightly thicker than leash assembly 14 because of the need to wind the two leash cords 136a, 136b vertically relative to each other instead of horizontally alongside each other, as is the case with leash assembly 14. Although not shown in any detail, it will be understood that a suitable locking mechanism may be provided to arrest rotational motion of hub 128.

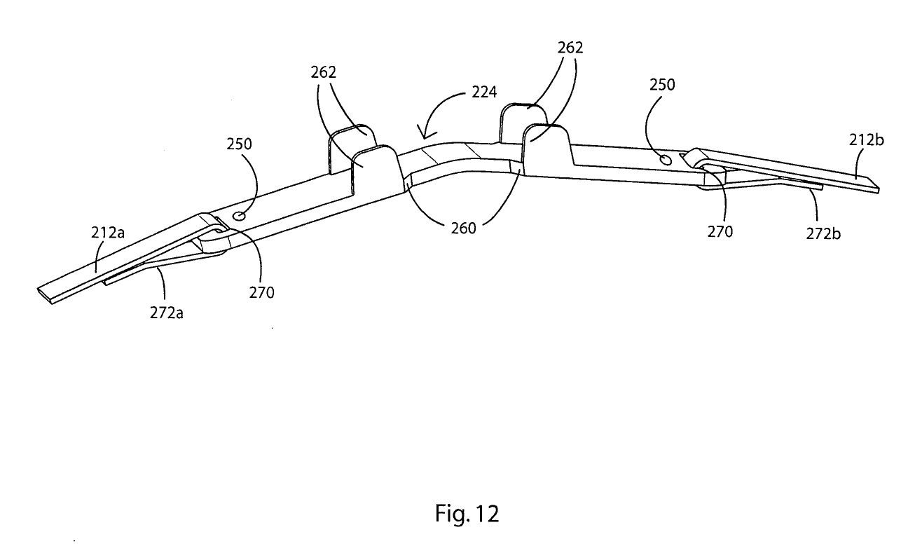

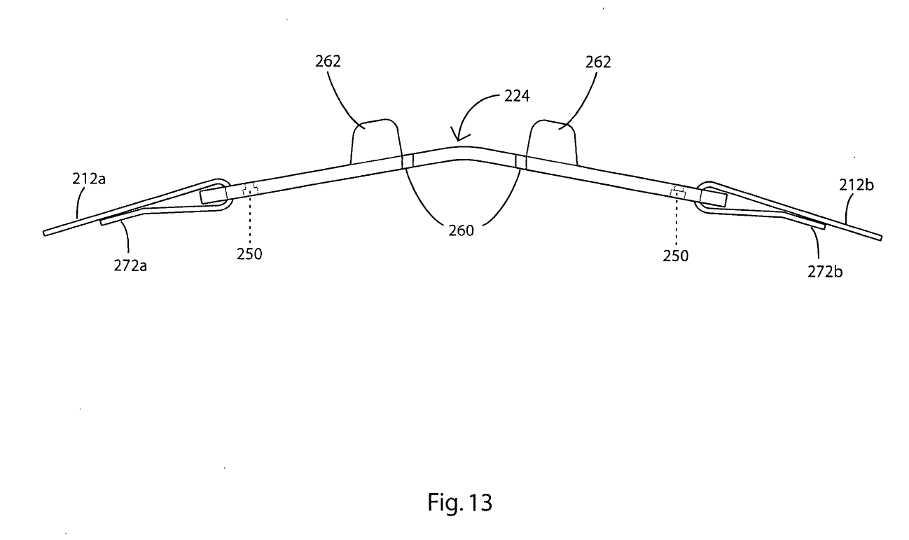

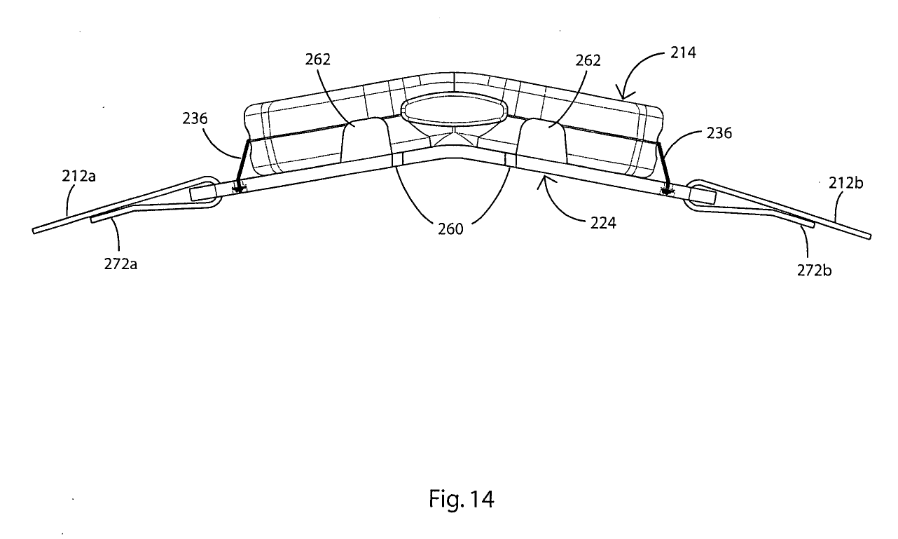

FIGS. 12-14 show a second embodiment of a locator base for use with a leash assembly 214 (FIG. 14), this second locator base being generally indicated by the number 224. Locator base 224 is permanently secured between two collar sections 212a, 212b, preferably at the time of manufacture of the collar. Locator base 224 defines apertures 270 in opposed ends of base 224. An end 272a, 272b of each collar section 212a, 212b, respectively, is threaded through one of the apertures 270 prior to being permanently fixed back onto collar 212a, 212b. Flanges 262 project upwardly away from lobes 260 of locator base 224. The curved convex profile of the locator base 224 is shown clearly in FIG. 13. Leash assembly 214 is seated in locator base 224 and cords 236 are anchored in apertures 250 in locator base 224.

It will be understood that while it has been disclosed that a first and a second leash cord extend between the base and leash assemblies, a single leash cord may be used or more than two leash cords may be used in the device without departing from the spirit of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A leash for attachment to a pet collar, where the collar includes a strap having connectors at either end; said leash comprising:
a base assembly adapted to be mounted to the strap;
a leash assembly detachably engageable with the base assembly;
a first leash cord connected between the base and leash assemblies; and wherein the leash assembly is movable between a first position where it is engaged with the base assembly and the first leash cord is substantially retracted within the leash assembly; and a second position where the leash assembly is spaced a distance away from the base assembly and a length of the first leash cord extends between the base and leash assemblies.

2. The pet collar as defined in claim 1, further comprising a retractor mechanism housed within the leash assembly, and wherein the first leash cord is secured at a first end to the retractor mechanism and at a second end to the base assembly.

3. The pet collar as defined in claim 1, wherein one of the leash and base assemblies further includes a locking mechanism, and said locking mechanism is selectively moveable between an engaged condition where retraction of the first leash cord is substantially prevented, and a disengaged condition where condition where retraction of the first leash cord is permitted.

4. The pet collar as defined in claim 3, wherein the retractor mechanism comprises a rotatable first spool mounted within the leash assembly; and the first leash cord winds onto the first spool when the first spool is rotated in a first direction and winds off the first spool when the first spool is rotated in a second direction.

5. The pet collar as defined in claim 4, further comprising:
a rotatable second spool mounted within the leash assembly; and
a second leash cord secured between the second spool and the base assembly; and wherein the second leash cord winds onto the second spool when the second spool is rotated in a first direction and winds off from the second spool when the second spool is rotated in a second direction.

6. The pet collar as defined in claim 5, wherein the retractor mechanism further comprises at least one coil spring operationally connected to one of the first and second spools; and wherein said coil spring biases the one of the first and second spools to wind the one of the first and second leash cords thereon.

7. The pet collar as defined in claim 6, wherein the second spool is disposed laterally adjacent the first spool; and the first and second spools rotate in opposite directions relative to each other.

8. The pet collar as defined in claim 7, wherein the first and second spools have gear teeth formed thereon, whereby the gear teeth of the first spool interact with the gear teeth of the second spool such that when the first and second spools are rotated to wind the first and second cords thereon they are wound thereon at substantially the same rate, and when the first and second spools are rotated to wind off the first and second cords therefrom, they are wound off at substantially the same rate.

9. The pet collar as defined in claim 8, wherein the locking mechanism includes a gear stop that is selectively engageable with one or more of the plurality of teeth on one or both of the first and second spools; and when the locking mechanism is engaged, the gear stop engages the teeth and substantially prevents rotation of the first and second spools; and when the locking mechanism is disengaged, the gear stop is disengaged from the teeth and permits rotation of the first and second spools.

10. The pet collar as defined in claim 9, wherein the locking mechanism further comprises:
a compression spring disposed between the gear stop and an interior wall of the leash assembly,
a release button extending from an exterior surface of the leash assembly and being operationally connected to the gear stop, and said locking mechanism is disengaged by depressing the button inwardly toward the exterior surface whereby the gear stop moves toward the interior wall and compresses the spring therebetween; and when the button is released, the spring expands and moves the gear stop away from the interior wall and the locking mechanism is engaged.

11. The leash as defined in claim 1, wherein the base assembly is ergonomically configured to be held in a human hand, whereby the leash assembly acts as a handle for the collar.

12. The leash as defined in claim 11, wherein the a first leash cord extends out from one side of the leash assembly, and the second leash cord extends out from a second side of the leash assembly, and the user's hand is adapted to extend around the leash assembly intermediate the first and second leash cords.

13. The pet collar as defined in claim 6, wherein the first spool is generally cylindrical and includes a first annular channel and a second annular channel spaced a distance from each other; and wherein the first leash cord is received in the first channel and the second leash cord is received in the second channel.

14. The pet collar as defined in claim 1, wherein the base assembly is one of fixedly mounted and releasably mounted to the strap.

15. The pet collar as defined in claim 14, wherein the base assembly is releasably mounted to the strap and the base assembly comprises:
a base having an interior surface that abuts a bottom surface of the strap; and
at least one spring-biased clip mounted on the base, said clip being configured to urge the base into engagement with the bottom surface of the strap.

16. The leash as defined in claim 1, wherein the base assembly has a bottom surface, and the bottom surface is concave in shape and is adapted to be complementary to a neck region of an animal.

17. The leash as defined in claim 1, the base assembly further includes at least one pad thereon, said pad being positioned to resist rotation of the collar on the animal.

18. A combined pet collar and leash comprising:
a collar comprising a strap with a connector at either end, said collar being adapted to be secured around the neck of an animal;
a base assembly mounted to the strap;
a leash assembly detachably engageable with the base assembly;
a first leash cord connected between the base and leash assemblies; and wherein the leash assembly is movable between a first position where the leash assembly is engaged with the base assembly and the first leash cord is substantially retracted within the leash assembly; and a second position where the leash assembly is spaced a distance away from the base assembly and a length of the first leash cord extends between the base and leash assemblies.

19. The combination as defined in claim 18, further comprising a retractor mechanism housed within the leash assembly, and wherein the first leash cord is secured at a first end to the retractor mechanism and at a second end to the base assembly.
